(19) United States
(12) Patent Application Publication
(10) Pub. No.: US 2010/0071136 A1
(43) Pub. Date: Mar. 25, 2010

(54) FOAM STRUCTURE SPACING SUPPORTS FOR MATTRESS CORES, UPHOLSTERY, AND PILLOWS

(76) Inventor: Erhard WEBER, Osnabruck (DE)

Correspondence Address: FOLEY AND LARDNER LLP;SUITE 500, 3000 K STREET NW, WASHINGTON, DC, 20007, US

(21) Appl. No.: 12/233,840

(22) Filed: Sep. 19, 2008

(51) Int. Cl. B68G 5/02; B32B 38/04

(52) U.S. Cl. 5/655.9; 156/252; 156/251

(57) ABSTRACT

Elastic compressible and flexible spacing supports out of foam or similarily compressible material is described for the filling of mattress cores, upholstery and pillows which are connected to one another as rib- or tube-like structures arranged in rows standing uprightly or lying horizontally and fixed at least on one side to an elastically resilient deck plate or cover.

These spacing supports avoid the stiffness of bulk foam and they are used in a variety of geometrical profiles.

They make possible a foam saving factor of two to three, a zone variation and the implanting of additional springy elements and they yield a superventilation of the mattress cores.

A roll packing of the cores or the finished mattresses is possible.

### INTRODUCTION

The invention concerns mattress cores, upholstery, and pillows which consist of a large variety of foam spacing supports placed between cover plates or sheathings in a sandwich construction having a considerably high foam volume saving factor of the inner core of two to three.

1. The main intention and advantage of the invention is:

To avoid the bulk stiffness of HR (High Resilient) foam (Polyurethane and -ether foam, in particular) by means of a variety of sandwich constructions.

The non-linear, kinking elastic characteristic of bulk foam, and therefore its progressive stiffness, results from the following:
For small compression strokes (1 to 2 cm penetration depth) the dependance of the stroke to the force (i.e. pressure×area) firstly is approximately linear.
Then the stroke to force curve strongly bends over since ever deeper lying foam areas are volume compressed, and
ever larger areas, reaching over the actual pressure-loaded area, from all sides are getting involved into the compression stroke.

Therewith the tension elasticity of the HR foam is stressed which inherently is restricted because of the foam plastic material and its bubble structure. For Latex or moss rubber foams out of natural or artificial caoutchouc the tension elasticity is higher. Because of their softness, their weight, and for not being porous for air, these foams are not very suitable for the spacing supports of the inner core construction.

Here the spacing support (ribs) running vertically or horizontally are arranged at a suitable distance in order to allow for an unhindered elastic compression and deformation for the applied stroke adjusting to the on-lying contour of the body. Thus for even a large compression factor, the elastic characteristic is approximately and in some cases less or more than linearly progressive.

For small rib width (1 to 2 cm) compared to the average distance, a buckling-in occurs for higher pressures and thus the characteristics of resilience becomes less than linear.

To this behalf the spacing support (ribs) are arranged in a practical distance with a volume filling factor of around ¼ to ½.

Only when approaching the bulk consistency for a compression to about ⅓ to ¼ of the original core height, the above described stiffness of bulk foam gradually sets in.

More advantages of the current invention of the sandwich construction compared to bulk foam (also contour cutted) cores are cited in the following, in particular, the huge variety of new degrees of freedom introduced:

2. The geometrical form and the height of the spacing supports can be chosen for different applications and be arranged in rows or layers.

The mode of installation is best defined with the plain of the inherent shape of the spacing supports. This plain is defined by the shape of the cross section of the figure or the running form of the spacing supports.

The spacing supports are arranged between a top and a bottom plate in a way defined by their plain of shape, either standing vertically uprightly or lying horizontally. They can run transversally or longitudinally in the mattress core, upholstery, or pillow

There are X-, V-, 8-, and sinusoidally shaped spacing supports, as well as hollow cylindrical or meandering ones, with all yielding excellent point elasticity.

With the spacing supports out of premium HR or Polyether or -urethane foams with high volume weight, it is possible also to make very soft mattress cores without running the risk of getting troughs, as for the soft bulk foam cores, even for heavy constant use.

For different applications, a geometrical variety of spacing supports are developed and cited.

3. The X-, V- and the sinusoidally shaped spacing supports can be developed out of a correspondingly precut parent block of foam, with the variations possible:
the length and the distance of the precut slots,
the height or width and the thickness of the final spacing supports,
the distance of the uncut pieces giving that of the connecting pieces or of the end pieces of the spacing supports,
the possibility of also cutting in the uncut pieces in a partial way through the parent block, thus reducing the height of the foam bridges connecting the spacing supports.

4. The possibility of implanting into the openings of the uprightly standing spacing supports:

pocket coils as singles or doublets, or

free spiral springs, or rings of wire or plastic, all with

varying shapes, height, and pre-tension,

varying implanting tightness, and

varying filling pattern.

By changing the dimensions of the implanted coils relative to that of the openings, i.e. the tightness, the following two extremes cases are possible:

a) The, e.g., barrel-shaped coils are freely moveable in the openings of the spacing supports even for the opening narrowing when compressed. That means, the largest winding diameter is somewhat smaller then the free diameter of the opening.

Then the outer coil windings, in particular of barrel-shaped coils, are largely free down to their largest (middle) winding. Thus a particular high point elasticity is guaranteed here.

b) The coils are fairly tightly fitting into the opening and by the compression-tightening also the smaller windings are successively somewhat hindered in giving-in.

This effect drastically reduces the elasticity/resilience of the combination: coil and surrounding foam spacing supports. Therefore both the coil wire diameter and the thickness of the support ribs can be considerably reduced to give the same resilience as the linearly added combination would give.

Thus as well foam volume as (steel) wire input can be saved.

Of course all intermediate cases are possible, offering a large variation of resilience and of zones in the mattress cores which can be supplemented by the application of
implanting only middle rings in the openings,
two small-sized, connected pocket coils in the slit-eyed openings of the, e.g., sinusoidal spacing supports,
free non-pocketed spiral springs, with the surrounding foam structure acting as pockets, advantageously of smaller height than the spacing supports.

Additionally, the frame structure of the mattress can easily be fortified by implanting along the longitudinal encasement one row and along the transversal encasement, e.g., two rows of pocket coils, see above.

5. Saving factors of the foam volume of at least 2 to 3 in the inner core are possible without any cutting loss or costs as, e.g., for the contour cutted cores, resulting in the inherent compression factors of two to three, with an additional compression factor of at least three, for the roll or compressed packing of the cores possible. Also a roll packing of the finished mattress made of spacing supports is possible.

6. An exceptional good ventilation and transpiration, comparable with Bonnell coil cores, and an additional pump effect of the chambers changing volume, because of the large part of air chambers of ½ to ⅔ of the inner core volume.

7. A large variability of the elasticity in and of different zones and of the mattress height is furthermore possible by choosing and varying:
the volume weight and/or the Indention Force Deflection (IFD) of the foam used, and moreover
the pocket coils in their (pretension) clothing implanted into the openings are completely decoupled from one-another by the surrounding spacing support ribs out of foam.
Because of the (sliding) guidance in the openings of the spacing supports, pocket coil heights and therewith also mattress heights of more than 30 cm are feasible, in particular for the two story version, with the mattresses having a much higher point elasticity than American box-spring mattresses.
transverse bars of (bulk) foam can be inserted in the Lordose zones for good support,
one or two rows of (pocket) coils can be implanted along the longitudinal or the transversal encasement, respectively.
The pattern of glueing the spacing support, in particular, to the top (and bottom) plate can be chosen.

With all of the cited points, the number of possibilities of zone variations are close to infinite.

8. These sandwich constructions are applicable for mattresses (designer mattresses as well, with very individual adjustment to weight and form of the bodies), for pillows, and also for upholstery, like couches, benches, car and airplane seats, truck and boat sleeping beds.

9. Also two and three story spacing support configurations are possible which can easily reach the height of box-spring mattresses and which will have a much higher contour adjustment facility.

10. Spacing support layers can also be used as toppers on one or both sides of mattress cores consisting of Bonnell or pocket coil inner cores, respectively.

11. One- or two-story spacing supports glued to foam-plates or -stripes find application as inner damping cores for waterbeds.

12. Simple assembling machines for the stretching- and the spreading-compression processes are designed for the making of the spacing support out of a parent foam block plus the simple mechanical slot-cutting apparatus of the latter are described or the block can be cut with a high pressure waterjet.

### Description of the Related Art

As yet mattress cores consisted of plain bulk or contour cutted foam or steel wire spring coils with or without a foam lining, respectively.

In the European Patents EP 0 624 332 B1 and EP 0 793 932 B1 an “Elastic springy element and springy support provided with such springy elements” are described, in the first claim: “Elastic springy element which comprise a tubular foam body (2) which is provided with holes (cavities) (3) extending inwards from the outside, characterized in that it comprises a wire spring (4) which is surrounded by the body.”

The foam structure spacing supports disclosed here are inherently different in as far as they consist of internally uncut foam support ribs and contain no holes or cavities. Their springiness and elasticity results from both the elastic volume compression and form deformation avoiding to a large extent the bulk stiffness of solid foam blocks because of their dimensional reduction to the mostly rib like structures.

The spacing have in the main no tubular body. The properties and characteristic features of the here claimed spacing supports are described in the 12 points of inherent advantages listed in the introduction.

### FIGURES

The FIGS. 1 to 13 illustrate the different geometrical form varieties of the foam spacing supports applicable for mattress cores, upholstery, and pillows. The X- and V-shaped, and the sinusoidal spacing supports can be formed out of slotted parent foam blocks by stretching/spreading-compression apparatuses which are also schematically sketched.

All forms of spacing supports, X's, V's, 8's, sinusoidal, or meandering bands can be used in mattress cores and pillows, standing uprightly (vertically) or running in rows horizontally which is exchangeable for all Figures shown. Besides the one-story configuration, for most spacing supports also a two-or more-story version is possible, easily allowing for mattress heights exceeding 30 cm.

The implantation of pocket coils, free spiral springs, or middle rings into the openings of the spacing supports opens further essential degrees of freedom for the resilience and the zone variation of the mattresses. The shown configurations and applications for mattresses and/or pillows are only representative examples with many other variations possible.

FIG. 1a: Cross section of part of a parent foam block 1 with length L′, width B′, and height H and with precutted transverse slots 2 and 3.

FIG. 1a: Cross section of part of a parent foam block 1 with length L′, width B′, and height H and with precutted transverse slots 2 and 3.

FIG. 1b: View onto two rakes 14 with prongs 16 inserted in the rows of slots 3 which stretch the parent block 1 from length L′ to length L of the inner mattress core.

FIG. 1c: View onto a part of a mattress stretched from the parent block 1 with precutted longitudinal slots 2′ and 3′ and the side longitudinal and transverse encasement beams 7 and 4, respectively.

FIG. 2a: Cross section of a part of a parent foam block 1 as in FIG. 1a.

FIG. 2b: Cross section of a foam block 1 cutting apparatus for the slots 2 and 3 with Guillotine-like 27 or triangular 27′ knives gliding through two compression plate 29, 29′.

FIG. 2c: View onto sinusoidal spacing support 15 formed from the parent block 1 by a spreading-compressing mechanisme, with implanted barrel-shaped-pocket coils 30.

FIG. 2d: Cross section of an implanting apparatus for the pocket coils 30 into the openings 12 of the spacing supports 15.

FIGS. 3a and a′: Cross section of a parent blocks 11′ with comb-like cutted slots 2 with different spacings.

FIGS. 3b and b′ Cross sections of a part of mattress cores with V-shaped spacing supports 5, 5′, 5″ in uprightly arranged rows and glued (9) between top 10 and bottom 10′ foam plates: undeformed (b) and deformed (b′).

FIG. 3c: View onto a mattress core consisting of rows of V-shaped, lying spacing supports 5.

FIG. 3d: Cross section of a pillow with V-shaped spacing supports 5 in a foam cover 20.

FIGS. 4a and a′: Cross sections of hollow cylinders 21, 21′ formed by rolling stripes of foam or foam bands clued (19, 19′) together at the touching lines.

FIGS. 4b and b′: Cross sections of mattress cores with hollow cylindrical spacing supports 21 connected with foam bridges 26 between a top 10 and a bottom 10′ plate: undeformed (b) and deformed (b′).

FIGS. 4c and c′: Cross sections of a pillow filled with hollow cylindrical spacing supports 21′, 21″ between a cover sheathing 20 of foamy material.

FIG. 5a: Cross section of a slot cutting machine with two rows of insertable knives 28 and two pairs of differently large rollers 22, 23 each driving two belts 60 for compressing and transporting the parent foam block 1.

FIG. 5b: View onto a synchronous stretching-compression apparatus fixed to a precutted, unstretched parent foam block 1.

FIG. 5c: View onto a synchronous stretching-compression apparatus forming an inner mattress core with sinusoidal spacing supports 15 stretched apart from the parent block 1.

FIG. 6a: Cross sections of an unstretched parent foam block 1′ with precutted longitudinal slots 2′ and 3′, with the same dimensions as in FIG. 1a.

FIG. 6b: View onto a stretching-compression apparatus for forming X-shaped spacing supports 15′ by means of waggons with hooking-iron-like needles 43 for fixation, with rhombic openings 12′ and glued on side 4 and transverse 7′ end encasement beams.

FIG. 6c: View onto a mattress core with X-shape spacing supports 15′.

FIG. 7a: Cross section of sinusoidal spacing supports 25 contour cutted out of a bulk foam block 1″.

FIG. 7b: View onto part of a one-story mattress core filled with rows of sinusoidal spacing supports, 25 which are clued (9) together at the extrema and between top 10 and bottom 10′ plates, and the side encasements 4,7 and with some inserted pocket coils 30.

FIGS. 7c and d: Cross section of a formed 8-shaped spacing support 55 and part of a one-story mattress core filled with rows of 8-shaped spacing supports 55.

FIG. 7e: Cross section of a pillow filled with layers of 8-shaped spacing supports 55′ in a cover sheathing 20.

FIGS. 8a and a′: Cross section of a one- and a two-story parent foam block 11, 11″, respectively, both with comb-like cutted slots 2″ and 3″ and encasement bar pieces 4′, 4″.

FIGS. 8b and b′: Cross section of a one- and a two-story mattress core filled with uprightly standing X-shaped spacing supports 35′, 35″: undeformed (b) and deformed (b′).

FIG. 8c: Cross section of a two-story mattress core filled with rows of uprightly standing X-shaped spacing supports 35 and 35′

FIG. 8d: View onto a two-story mattress core filled with rows of uprightly standing X-shaped spacing supports 35, 35′.

FIG. 8e: Cross section of a pillow filled with a row of uprightly standing X-shaped spacing supports 35.

FIGS. 9a, c and e: Cross section of slotted (2, 3) and contour cutted parent foam blocks 21, 21′ and, 21″, respectively.

FIG. 9b: View onto a pillow filled with rows of sinusoidal spacing supports 15 standing uprightly.

FIGS. 9d and f: Cross section of pillows filled with uprightly standing sinusoidal spacing supports 15 in a half bone- and wedge-form, respectively, with a bottom foam plate 57 and cover 20′ out of foamy material.

FIG. 10a: Cross section of a part of a mattress core filled with vertically running rows of meandering spacing supports 45.

FIG. 10b: Cross section of a pillow filled with bands of meandering spacing supports 45.

FIGS. 10c and d: View onto and cross section through a continuous forming apparatus of the meandering spacing supports 45.

FIG. 11a: View onto part of a mattress core filled with uprightly standing meandering spacing supports 45′ filled with pocket coils 30.

FIGS. 11b and c: View onto and cross section of a continuously pocket coil-implanting apparatus into the simultaneously formed meandering spacing supports 45′.

FIGS. 12a and b: View onto and cross section of a mattress core consisting of a Bonnell spring 72 story and a topper of sinusoidal spacing supports 15 between a top 10 and bottom 10′ plate.

FIG. 12c: Cross section through a mattress core out of a pocket coil 72 middle part with a top 75 and a bottom 75′ topper of sinusoidal spacing support 15.

FIGS. 13a and b: View onto and cross section of an inner damping core of a waterbed consisting of sinusoidal spacing supports 15 glued between a top 10 and a bottom 10′ plate.

FIG. 13c: Cross section through dito with the spacing supports 15 clued between top 70 and bottom 70′ foam stripes.

FIG. 13d: Cross section of an inner damping core of a waterbed consisting of a two-story spacing support 15 configuration glued between three foam plates 80′, 80, 80″.

### DETAILED DESCRIPTION OF THE INVENTION

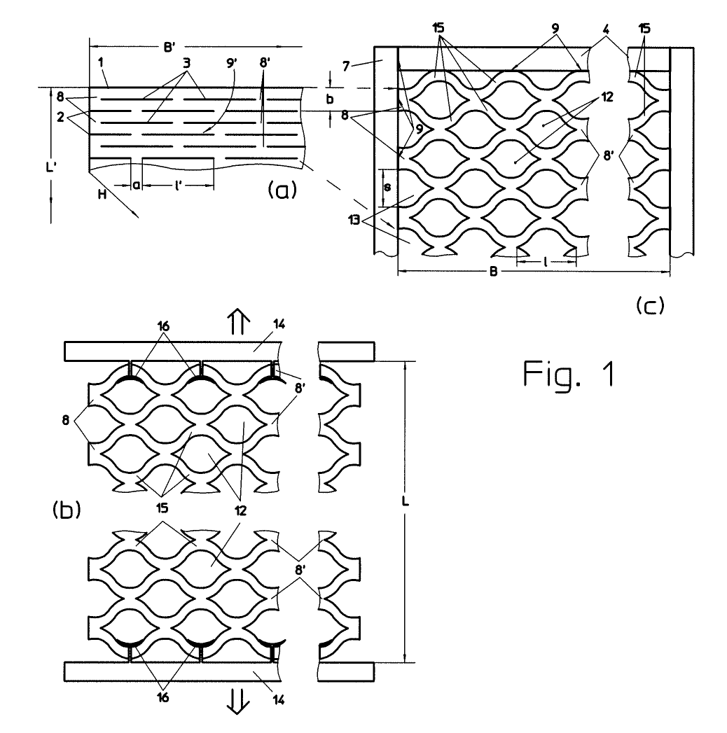

FIG. 1a shows the cross section of a parent foam block 1 of width B′ and length L′ having alternating rows of slots 2 and 3 with a distance b/2 which run parallel to its width B′ and are cut through all of its height H with the slots 2 and 3 having a length l′ and distance pieces 8 and 8′ with a distance a from the rim and to the next slot, respectively.

Each alternating row is shifted by (l′+a)/2 to the neighboring one, thus each second row has a slot 2 open at the rim of the parent block 1.

In order to get the inner core of the mattress, shown in FIG. 1c, the slotted parent block is compressed in its width from B′ to B and simultaneously stretched from length L′ to the final length L of the inner core, see FIG. 1b.

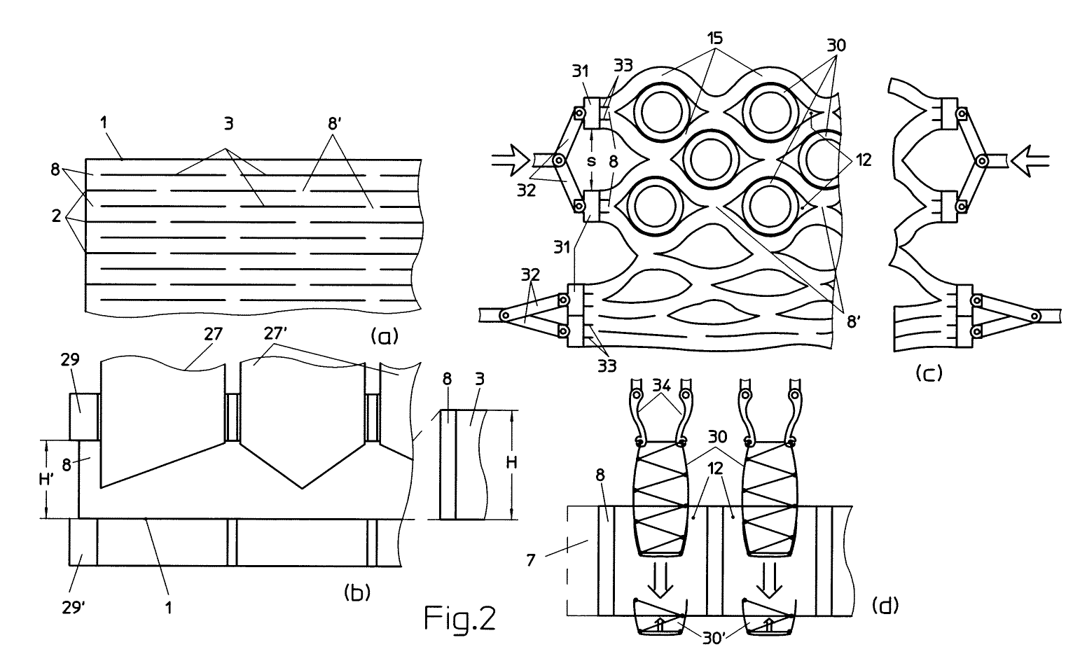

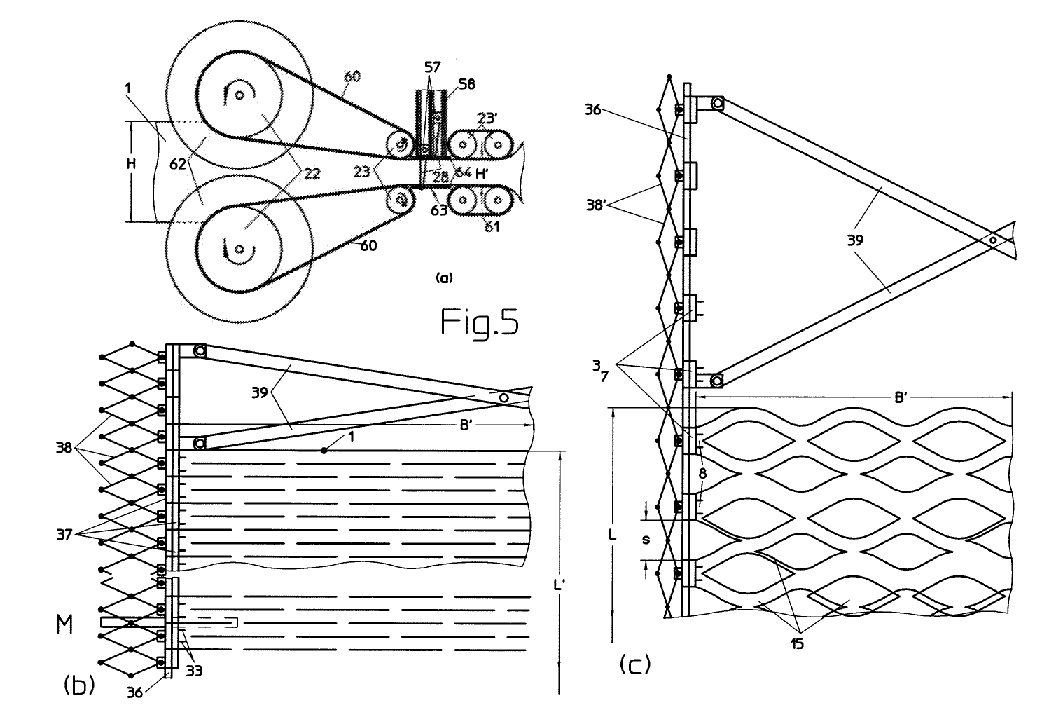

By means of a cutting apparatus, see FIGS. 2b and 5a, slots 2, 3 are cut through the parent foam block 1 in alternating rows such that one row of slots 2 are open to the sides and the other row has a closed end piece 8, and the slotted block 1 is rolled or sprayed with clue 9′, 9 on top and on the sides before stretching.

In FIG. 1b a rake 14 with prongs 16 is inserted in the first and the last row of slots 3 and stretches the parent block 1 from length L′ to the length L of the inner mattress core resulting in the compound sinusoidal structure of uprightly standing ribs 15.

Then the side 7 and transverse 4 encasement beams and a top plate 10 out of foam is clued and pressed against the inner core, see FIG. 1c.

After turning this unit around the go through zero of the sinusoidal ribs 15 and the side and transverse encasement beams is pointwisely or in stripes rolled with glue 9′, 9 and then the bottom plate 10′ is pressed to it.

With a device in which the parent blocks hangs and is stretched vertically, both sides of the parent block 1 and the encasement 4, 7 can be sprayed or rolled with glue 9′, 9 in one operation thus saving time.

In particular, by using zones with different spacings between the row of slots 2, 3 the formation of waists can occur when stretching the block 1 which can lead to a minorly wavy contour of the encasement. This can be repaired by cutting the side encasement beams in the complementary wavy structure or by using the synchronous stretching apparatus of FIGS. 5b and c.

For the cutting of the slots 2 and 3 into a parent block 1 one can use also a very thin high pressure (2000 to 4000 bar) waterjet, possibly with two or four simultaneously operating heads.

To avoid spilling by the waterjets the parent block 1 is placed onto a comb-like grill out of thin razor-like blades out of stainless steel.

By means of the compression, the slots with a parent length l′ become slit-eyed openings of length l with an inner circumference of 21′, or described differently:

The stretching/compression results in vertically, uprightly arranged sinusoidal spacing supports 15 of rib-width b/2, see FIG. 1c, which are connected at the extrema by the slotdistance pieces 8′ and end pieces 8 of length a each.

The zero crossings 8, 8′ at the block 1 rim of total width b of the interconnected sinusoidal spacing support 15 are then separated by the distance s, as shown in FIG. 1c.

Before the stretching-compression process the upper side (and possibly also the lower side when using a hanging assembly line) of the slotted parent block 1 is rolled or sprayed with glue 9′ and then the stretched spacing supports 15 are glued onto the bottom plate (10′) and to the top plate (10) (not shown) of the mattress core, and thus hold fixed.

The transverse encasement beams 4 may be part of the inner core with its width cut to the compressed width B of the stretched core.

In FIG. 2b the cross section of a cutting apparatus for the slots 2, 3 (2′, 3′) into the parent foam block 1 (1′) is shown, see FIG. 2a. It consists of two plates 29, 29′ compressing the block 1 from its original height H to H′≈3H/4 or H/2, in order to secure a defined cutting-through without any lateral shifts. In these plates 29, 29′ several rows of Guillotine-like 27 or triangular 27′ knives are inserted which can cut all through the compressed foam block 1.

This cutting-through of the parent block 1 in several rows in one operation is rationally, fastly and cheaply performed and thus saves glue connections in the inner core of the mattress.

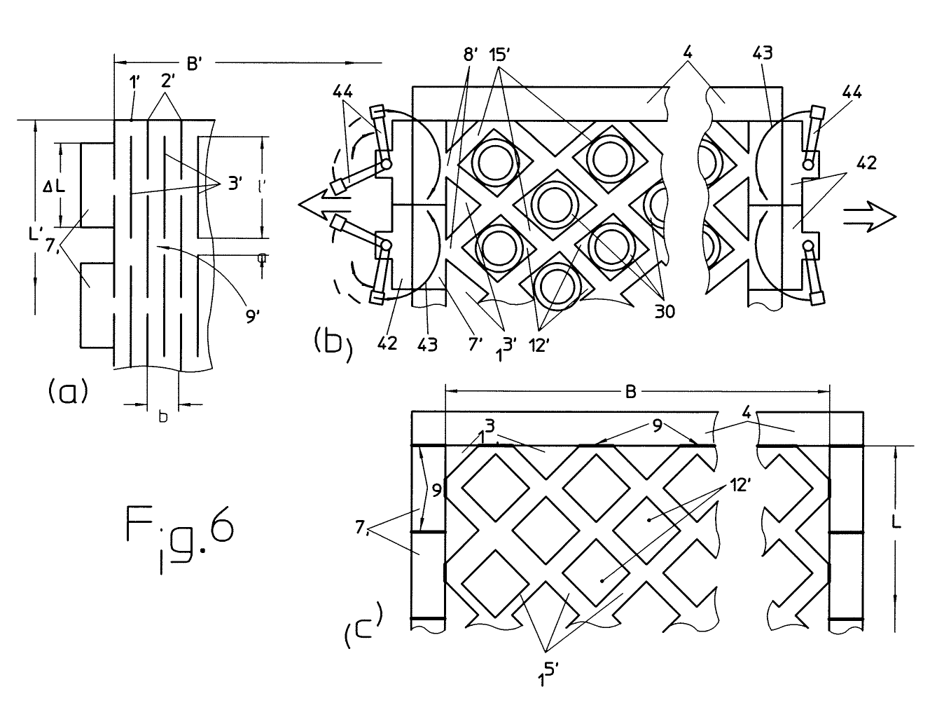

With the automated stretching-compression (FIGS. 2c and 5b, c) and the spreading-compression apparatus (FIG. 6b) a very rational assembling of the mattress core is achieved, in particular,

because of the spraying- or rolling-on of the slotted parent block 1 (1′) with glue for the later fixation of the spacing supports 15 on the bottom 10′ (and top 10) plate of the mattress. The separate glueing of the foam top plate (10) can advantageously be reduced to the zero cross overs 8′ and the end pieces 8 of the spacing supports 15 and the beams 4, 7 (7′).

The transport/packing of the cutted parent foam blocks 1, 1′ is very rational and compact because of the inherent compression by factors two to three, with a further packing compression factor of about three possible. Also a roll packing of the mattress cores or the finished mattresses, respectively, is possible.

The spreading-compression apparatus is schematically sketched in FIG. 2c. Two waggons 31 each connected to a pair of scissors 32 are fixed with needles 33 in the outer distance pieces 8 of the going-to be sinusoidal spacing supports 15 and are pulled apart to a distance s and simultaneously the width B′ of the block 1′ is reduced to the width B of the final core, see FIG. 1.

A forced synchronisation is achieved analogously to the spreading-compression apparatus of FIG. 5, with two pairs of scissors (39) at each end of the mattress core.

In the slit-eyed 12 (or rhombic 12′) openings of the spacing supports 15 in FIG. 2c barrel-shaped pocket coils 30 are inserted which gives a considerable increase in the resetting characteristic of the spacing supports 15.

This opens up new degrees of freedom for zone variations of mattress cores.

In FIG. 2d the implanting apparatus of the pocket coils 30 is schematically shown.

The pocket coils 30 are gripped with pairs of plyers 34 and are placed into the openings 12 of the spacing supports 15. One, two, or more rows of pocket coils 30, or spiral springs, or middle rings are inserted in one operation.

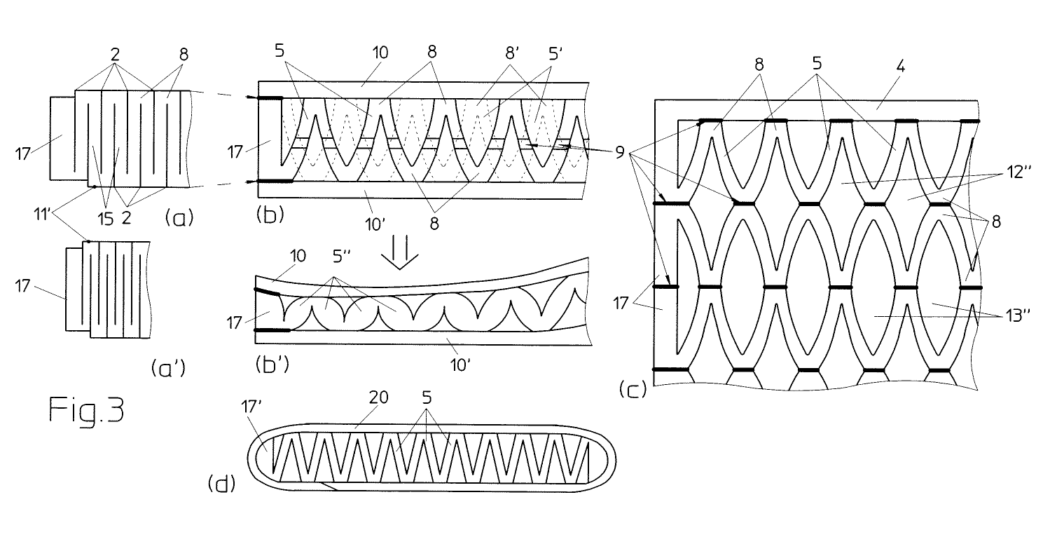

In FIG. 3 uprightly standing V-shaped spacing supports 5 are shown with the cross section of the parent foam block 11 sketched in FIGS. 3a and a′, with different distances between the slots 2.

These slots 12 are cut comb-like and alternating from the top and the bottom of the block 11 with an uncut distance 8 to one side each and thicker encasement pieces 17 at both ends.

The parent block 11 is then stretched by a factor of two to three to give the vertically arranged V-shaped spacing support ribs 15 shown in FIGS. 3b and b′ which are placed and glued (9) between a top 10 and a bottom 10′ plate.

For inherent stabilization and/or zone variation the next row of V's , see FIG. 2b, may have a phase shift of 180 degrees to the neighbouring one, i.e., the corresponding parent block 11′ is just turned upside-down by 180 degrees.

The encasement pieces 17 clued (9) together become the longitudinal (or transversal) encasement 4 and are also clued (9) to the V's.

FIG. 3b′ shows the partly deformation of one row of V's 5″ under compression.

In FIG. 3c the view onto a mattress core with horizontally lying rows of V-shaped spacing supports 5 is shown.

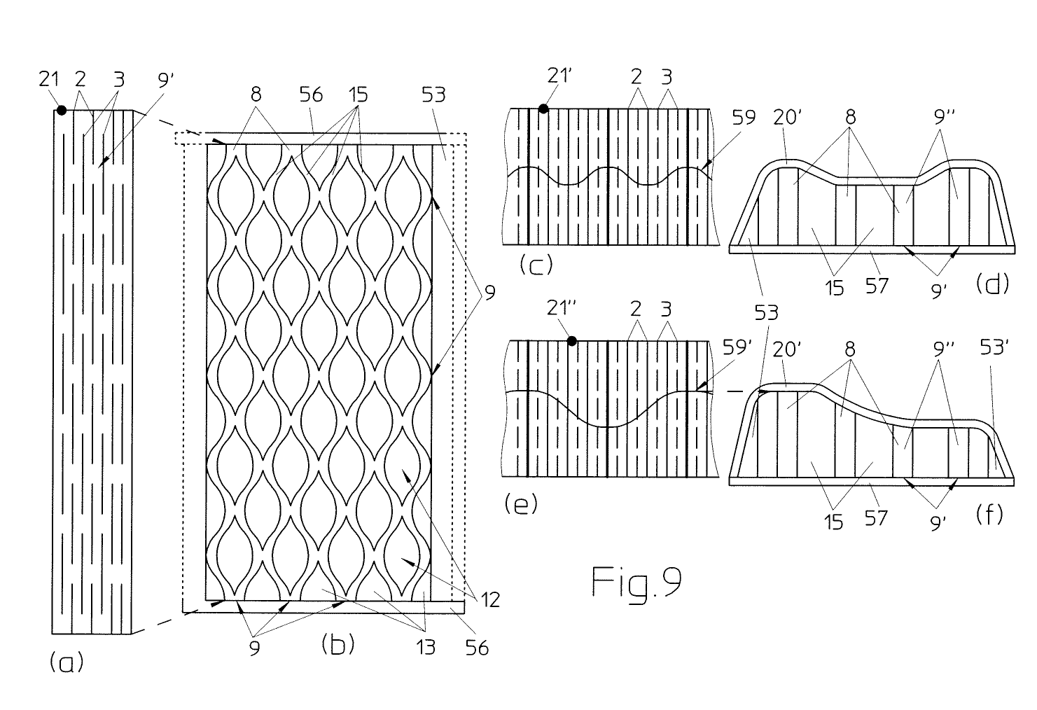

In FIG. 3d the cross section of a pillow is shown, with uprightly standing V-shaped spacing supports 5 also obtained by stretching a parent block (11′) with half round end pieces 17′, all surrounded by a sheathing 20 of HR- or of visco-elastic foam 20 or of a fleece material. For differently contour shaped pillows, see FIG. 9.

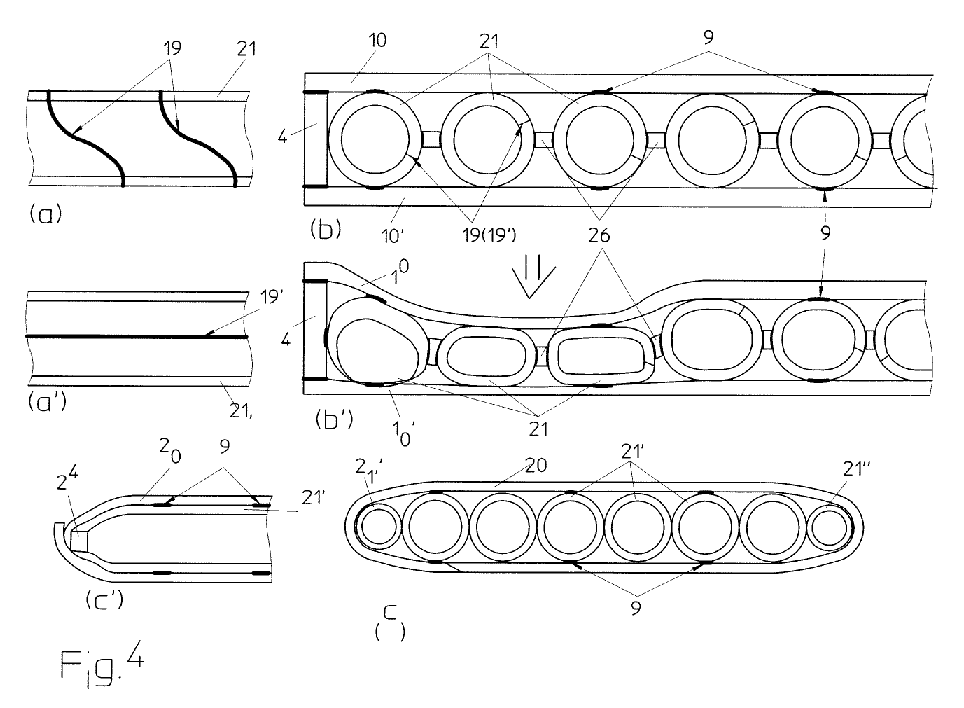

In FIG. 4 foam spacing supports have the form of a hollow cylinders 21, 21′ connected by foam bridges 26.

In FIGS. 4a and a′ the longitudinal cross section of the hollow cylinders 21, 21′ are shown which are produced either by winding foam strips roundly and glueing (19) it together at the edges or by folding a foam band to form the hollow cylinder 21, 21′ and glueing (19, 19′) at the longitudinal edge.

FIG. 4b shows the cross section of a mattress core with hollow cylinders 21 separated by foam bridges 26 arranged transversally (or longitudinally) between a top 10 and a bottom 10′ plate and the encasement beams 4 (or 7).

FIG. 4b′ sketches the deformation of FIG. 4b by a partly compression. Here the cylinders 21 are partly deformed into squares and the foam bridges 26 are compressed as well.

For very heavy pressure load the hollow cylinders finally become flat and the bulk elasticity characteristic will become valid, see above in the introduction.

It is possible to fix each, every second, or third cylinder to the top 10 and bottom 10′ plate by glueing (9) on the contact lines or on several spots. When some of the cylinders 21 are left free, an interaction between the strongly compressed cylinders and the neighbouring not so strongly compressed once takes place, giving rise to an interaction with a small positive adjustment stroke. This includes a shift of the cylinders 21 which can be assisted by applying a fabric lining, e.g., Corovin® under the top 10 and on the bottom 10′ plates for better gliding.

In FIGS. 4c and 4c′ the longitudinal and the transverse cross sections, respectively, of a pillow filled with hollow cylinders 21′, 21′″ of larger outer diameters (21′) in the middle and smaller diameters (21″) at the ends of the pillow.

Again a sheathing 20 covers the cylinders 21′, 21″, which tapers off at the end and which is glued to a flatish connexion piece 24 of soft foam.

Of course, the hollow cylindrical or the V-shaped spacing supports 5 from FIGS. 3 and 4 can also be used in uprightly standing rows glued together at the touching points and in the openings of which can be inserted additional springy elements 30.

In FIG. 5a a further mechanical cutting apparatus is shown which consists of two pairs of rollers 22 and 23 for a belt 60 each with the width of the foam block 1 to be cut. The two large rollers 22 have cheeks of larger diameter in order to keep the width of the foam block 1 when fed into the belts 60 and to avoid a transverse extension when compressed. The front rollers 22 have, e.g., a diameter of approximately H, with H=height of the foam block 1, and the smaller rollers 23 have a diameter H′ of the dimension of the compressed height H′ of the block 1. The envisaged ratio H/H′ may lie between three and five.

The running belt 60 driven by the two rollers 22 and 23 each compresses and simultaneously transport the block 1 between two slotted guiding metal plates 64 eventually coated with Teflon®.

In the slots 63 of the metal plates 64 two rows of knives 28 stick with the correct frequency through the compressed block 1. The row of knives 28 glide with bushings 57 in the corresponding rails 58.

The transport velocity of the compressed block 1 and the frequency of the knives 28 is synchronized to give the cutting pattern of that shown in FIG. 5b. The cutting through and the pull back movement of the row of knives 28 advantageously take place hydraulically.

If necessary, two small rollers 23′ with belts 61 catch the compressed, slotted block 1 directly behind the guiding metal plates 64. The rollers 23′ rotate with the same rotary velocity as the rollers 23′ of the same diameter in front of the metal plates 64, and thus prevent a compression in the direction of the slot cutting.

By changing the distance between the knives 28 in both rows and the cutting frequency, the cutting pattern can arbitrarily be changed.

The belts 60, 61 have a rough surface in order to transport the compressed block 1 with the velocity of the belt.

This mechanically, continuously operating cutting apparatus is an inexpensive alternative to the high pressure waterjet cutting and is suited for mass production.

FIGS. 5b and c shows the view onto a stretching-compression apparatus capable of transforming the slotted (2, 3) parent block 1 of foam of width B′ and length L′ into the stretched sinusodial spacing supports 15 of the size B and L of the inner mattress core. This stretching-compressing process is performed by means of gliding waggons 37 running in rails 36 symmetrically arranged on both sides of the block 1 or of the to become inner mattress core, respectively.

These waggons 37 are fixed to the go-through-zero end pieces 8 of the spacing supports 15 by means of needles. The waggons 37 are connected to a multiple pair of scissors 38 arrangement which performs the measured stretching of the end pieces 8 to the desired distance s by moving apart the waggons 37 gliding in the rails 36, resulting in the stretching of the block 1 length L′ to the length L of the inner mattress core.

The synchronous, corresponding compression from B′ to B is performed by two pairs of large scissors 39 at each end of the block 1 which are also connected to two waggons 37 running in the two side rails 36 each.

With the starting distance and the length of the pair of scissors 39 chosen such that the stretching/compression ratio in question is achieved.

Advantageously the multiple pairs of scissors 38 are hold fixed in the middle (M) of the arrangement. The table, the spacing supports 15 are gliding on, is covered with Teflon or a fabric not hindering the movement and/or the resistance is reduced by means of grooves with a small top area machined into the table.

Or the complete stretching procedure can be carried out with a vertically arranged apparatus. Then to both sides of the parent block 1 glue 9′ can be applied before stretching. The assemblage to the finished mattress core is then performed as described for FIG. 1.

In FIG. 6a the view onto a spreading apparatus is depicted which produces the X-shaped spacing supports 15′ from the slotted (2′, 3′) parent foam block 1, shown in FIG. 6a. To this behalf waggons 42 are fixed to the encasement pieces 7′ by hooking-iron-like needles 43 pushed into the frame pieces 7′ by means of rotating arm 44 mechanisme. Then the hooked-in waggons 42 are pulled outwardly in order to transform the slotted block 1′ into the X-shaped spacing support 15′.

The synchroniced movement of the encasement pieces 7′ and the spreadching-apart of the X-pattern is accomplished by multiple pairs of scissors (not shown) attached to all the waggons 42 and arranged in a transversal row on both ends of the mattress core (not shown), with the length of the scissors pairs matched to the movement required, compare FIGS. 5b, c. In the rhombic openings 12′ of the X's, pocket coils 30, spiral springs, or middle rings can be implanted. The filling-in pattern can, of course, be varied for all openings (12) 12′ filled, to each second, third, etc., filled, with any thinkable pattern.

For a stabilization of the mattress core at the encasement, the triangular openings 13′ (as well as the peaked vault-shaped openings 13 of the sinusoidal spacing support 15) can be filled each or every second opening 13′ (13) with (two) pocket coils of smaller winding diameters (not shown).

In FIG. 6c part of the finished mattress core with X-shaped spacing supports is shown.

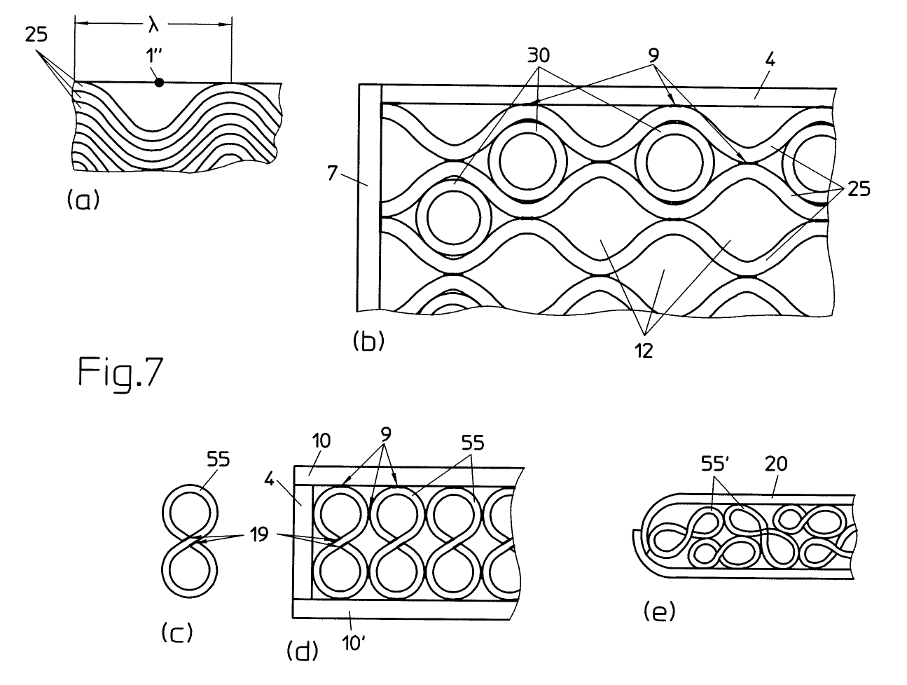

In FIG. 7 some more spacing support variations are sketched.

In FIG. 7a sinusoidal spacing supports 25 are cut out of a parent bulk foam block 1″ by means of a usual contour cutting machine. These sinusoidal wave bands 25 are then arranged standing uprightly in a mattress core, the view onto which is shown in FIG. 7b, and are glued (9) between a top 10 and a bottom 10′ plate, with beams 4 (7) of the encasement, and are glued (9) together at the extrema.

The sinusoidal spacing support bands 25, 25′ have a width of λ/3 to λ/2, with λ=wavelength of the sinusoidal band, and are arranged alternating with a face shift of 180° between neighbouring bands.

For a better interaction of adjacent λ-areas of the sinusoidal spacing support bands 25, 25′ each second or third extrema of the sinusoidal band supports 25, 25′ can be fixed by glueing it to the plates 10, 10′. The neighbouring bands can be glued (9′) together at the extrema.

Of course the profile cutted, sinusoidal spacing support bands 25, see FIG. 7, can also be glued (9) only in parts of the height H, either in the middle or on the upper and/or lower part of it.

Then also a similar two-story configuration is possible with an upper and a lower sinusoidal spacing support band 25 running horizontally above one another and glued (9′) together at the touching points (not shown).

This gives a variation in the resilience of the support ribs (15, 25), in particular, also when pocket coils are implanted in the slit-eyed openings (12) of the sinusoidal or X-shaped supports 15 and 15′, respectively.

In FIG. 7c a spacing support 55 in form of an 8 is shown which is obtained by forming a stripe of foam into the 8 and clueing (29) it together at the touching line. These 8-shaped supports 55 are arranged in FIG. 7d standing vertically (of course also lying horizontally possible) between the top 10 and the bottom 10′ plates of the core to which they are glued (9) at the touching lines, advantageously pointwisely, and (partly) also to their neighbours. In FIG. 7e, a pillow is filled with 8-shaped supports 55 piled up in between a cover sheathing 20 out of foam or fleece. The layer can be arranged in different fashion so as to fill the pillow.

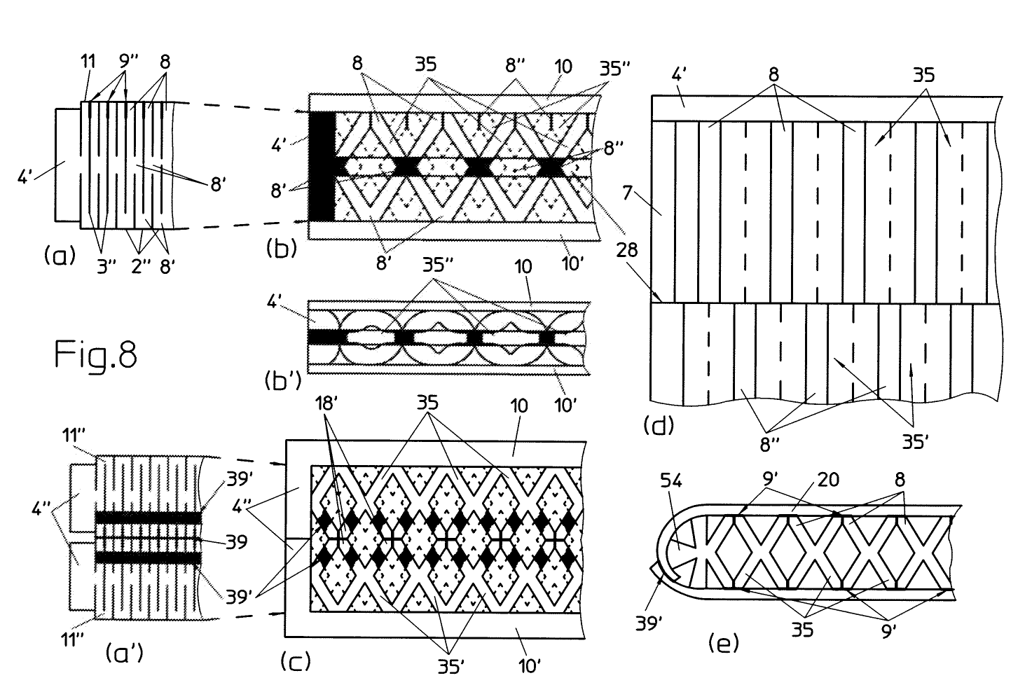

FIGS. 8b, b′ and c shows the cross sections of a one- and a two-storied mattress core, respectively, with horizontally running X-shaped spacing supports 35 spreaded out of the slot (2″, 3″) cutted parent blocks 11, 11″, see FIGS. 8a and a′.

The block 11 in FIG. 8a is cut with slots 2″ and 3″ reaching almost through the height H of the block with uncut end pieces 8, and with slots 3″ from both sides almost to the middle uncut pieces 8′, respectively.

Then the slots 2″ are glued (9″) together to give the same length end pieces 8′ as on the other uncut side of the slots 2″. The block 11 (11″) is pulled apart to give the X-shaped spacing supports 35 which are glued to the top 10 and bottom 10′ plate with the end pieces 8, 8′ for fixation.

In FIG. 8c the uniformly compressed mattress core with the compression-deformation of the X-shaped spacing supports 35″ is shown.

FIG. 8d shows the view from above onto the end pieces 8 and 8″ of the X-shaped spacing supports 35 and 35′ of two rows of X's running transversally (longitudinally) in the mattress core and glued together by means of a flexible band 18 at the middle uncut pieces 8′ and 8″. This arrangement in rows of X's can be used as a stabilization and as a zone variation, with the foam spacing supports 35 and 35′ having different volume weight, compression shore hardness and also possibly width of the legs of the X's.

In FIG. 8c the analogous arrangement for a two-story configuration with the, in principal, same numeration for the two parent blocks 11″ is shown glued (9, 9″) together. Here a flexible band 18 can be replaced by two Stripes of glue 39′ applied already to the parent block 11′ before stretching to give the X-spacing supports 35, 35′ above one another.

This two story configuration can easily reach an all over heights of 35 cm, including top 10 and bottom 10′ plates which makes it at least comparable to the height of an American box-spring mattress, but with much higher point elasticity.

Because of the horizontally running, uprightly arranged rows of X's, in this case no pocket coils or spiral springs can usefully be inserted into the openings (12′) formed by the X's. p In FIG. 8e a pillow is shown, the cover sheathing 20 of which, is filled by stretched, horizontally running X-shaped spacing supports 35 with a half-cross 54 of foam at the end. The cover 20 is clued (39′) together at an overlapping end stripe and the X's are pointwisely glued (9′) to the cover 20.

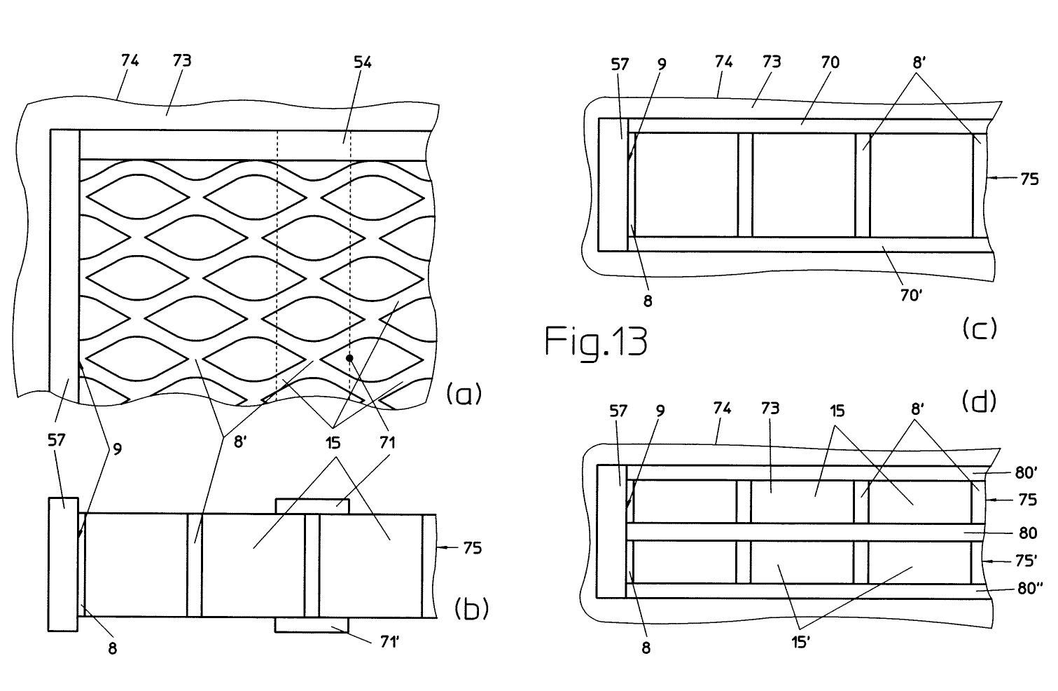

Similarily also a two-story configuration of two, e.g., sinusoidal (or X-shaped) spacing support 15 (15′) planes 75, 75′ can be clued between a top 80′, a middle 80 and a bottom plate 80″, see FIG. 13b.

FIGS. 9b and d, f show the view onto and cross sections of, respectively, two pillow configurations of different shape that originate from slotted (2, 3) and contour cutted parent foam blocks 21, 21′, 21″. The slotted (2,3) foam block 21, 21′ or 21″, see FIGS. 9a, c, and e, are stretched by a stretching-compression apparatus, as sketched in FIGS. 5b and c, to give the sinusoidal spacing supports 15 running longitudinally in the pillow, as shown in a view from above in FIG. 9b.

The stretched sinusoidal spacing supports 15 are then fixed with glue 9′, applied onto one side of the parent block 21′ before spreading, to a thin bottom sheath of foam 57, see FIGS. 9d and f. A top cover sheath 20′ with two foam wedges 53 (53′) on both sides of the sinusoidal spacing 15 rows is then glued (9′) pointwisely to these and the top of the spacing supports 15. And foam side frames 56 complete the pillow. The cover sheath can be of HR or Latex foam, visco-elastic foam or out of an artificial fleece material of 1 to 3 cm thickness, respectively. The behaviour and the elasticity characteristic of this pillow is at least comparable to a pillow with pegged Latex or contour cutted HR foam cores.

The excellent ventilation and transpiration, and the pump effect because of the multiple chambers/openings (12, 13) makes it an ideal pillow for a healthy sleeping climate in bed. The outer shape of the pillow can vary between half-bone-, FIG. 9d, wedge-shaped, FIG. 9f, or a flat version, FIG. 9b, which all can be cut out of the contour cutted parent blocks 21, 21′ and 21″ along the lines 59 or 59′ without any cutting loss, see FIGS. 9c and e.

For a variation of the compression resilience, for instance, the outer double row of sinusodial spacing support 15 can be made out of foam with different volume weight, compression hardness, or rib width, see FIGS. 9c and e.

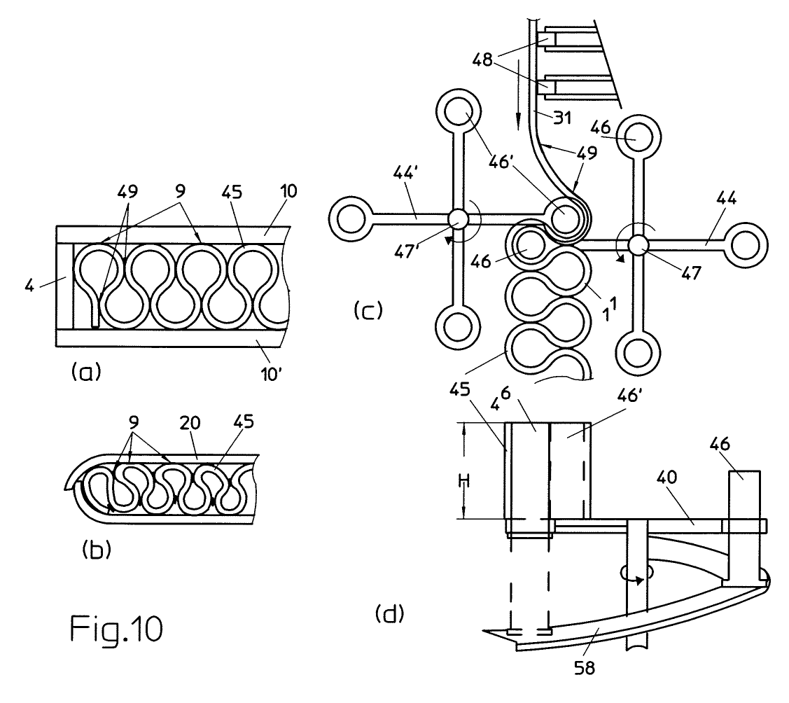

In FIGS. 10c and d the view onto and the cross section of an automatic, continuously forming apparatus for a meandering foam band of spacing supports 45 is sketched.

This meandering band of spacing supports 45 is horizontally running in a mattress core, see FIG. 10a, between the top 10 and bottom 10′ plates and the side frames 4 (7) of the encasement, or in a pillow between a cover sheathing 20, to all of which it is pointwisely glued (9) to, see FIG. 10b.

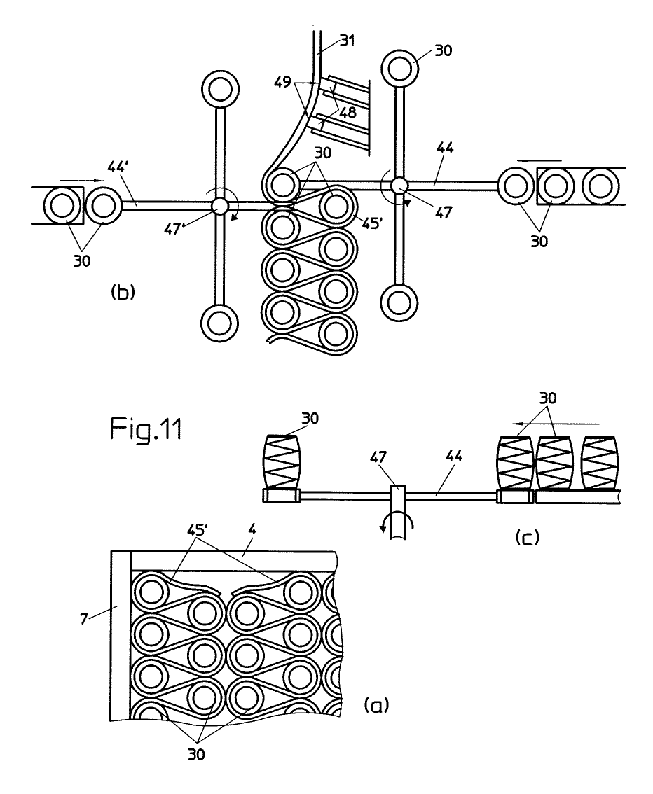

Of course it (45) can also be arranged standing vertically, uprightly, see FIG. 11a, similar to the sinusoidal 15 or X-shaped 15′ spacing supports of FIG. 1, 5 or 6 for example.

The forming apparatus for the meandering spacing supports 45, FIGS. 10c and d, consists of two gear wheel-like interacting crosses 47, 47′ rotating synchronously clock- and counter clock-wise, respectively, and having at the end of each cross arm 44, 44′ a round forming poles 46 (46′) standing up perpendicular to the cross planes.

A stripe of foam 31 of width (height) H is fed into the two gear-wheel-like interacting crosses and thus formed into the continuous meandering spacing supports 45.

Glue stripes 49 are applied by means of rolls 48 running at an angle to the moving foam stripe 31 so as to give via the movement a perpendicular strip of glue 49.

After the circles in the meandering band of the spacing support 45 are formed, the poles 46, 46′ are clicked off the arms of the crosses and can fall or are pushed by means of a spring mechanisme out of the circles onto a belt 58. This belt is snail-likely arranged under each cross and thus heaves the forming poles 46 (46′) again upwardly into their working position at the arm ends 44, 44′ of the crosses 47, 47′ where they are clicked in again, see FIG. 10d. In an analogous way the round openings of the meandering band 45 are filled with pocket coils 30 or the like by a continuously working machine, as depicted in FIGS. 11b and c.

The apparatus is set-up like that in FIGS. 10c and d, but instead of the poles 46, 46′, pocket coils 30 are hold fixed at the end of the cross arms 44, 44′ and are released when they are surrounded by the circles in the meandering foam stripe 31. Further pocket coils 30 are fed to the arm 44 as shown in FIG. 11c. The resulting standing uprightly meandering spacing support band 45′, shown in FIG. 11, are clued pointwisely together and between frame bars 4 and 7 of the encasement and to the top 10 and bottom 10′ plates.

Of course, also a combination of the apparatus in FIGS. 10c, d and 11b, c can be used to fill only every second or fourth, etc., opening with additional elastic springy elements.

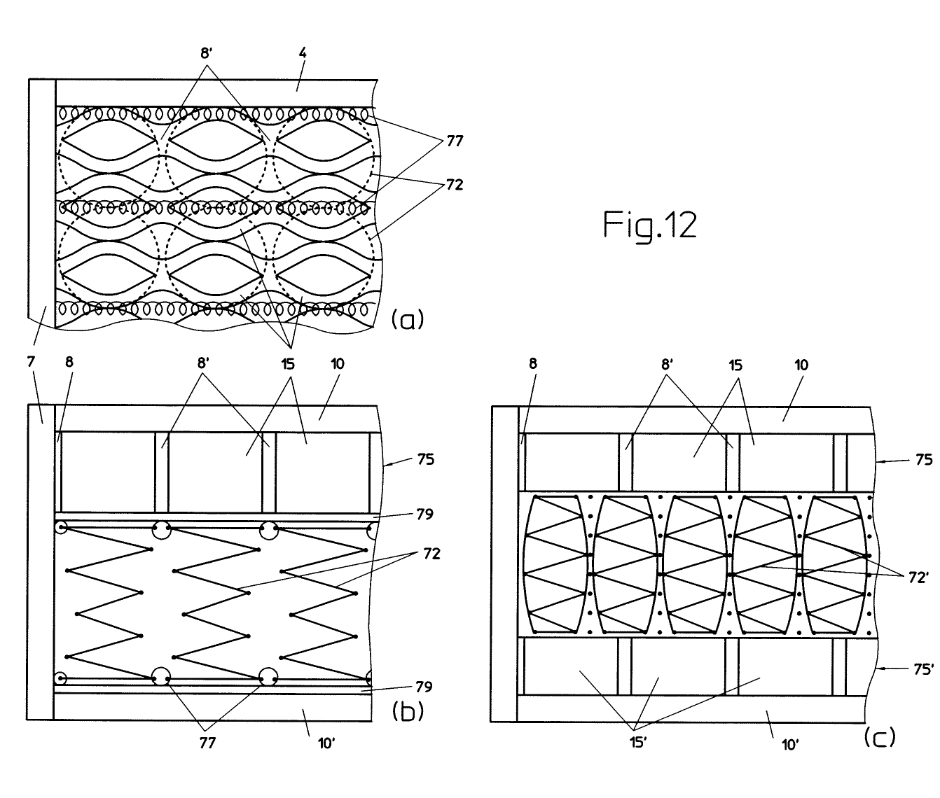

In FIGS. 12a to c are shown multi-storied mattress cores consisting either of one story of Bonnell 72 or pocket coils 72′ with one topper 75 or surrounded by two toppers 75, 75′ consisting of, e.g. sinusoidal spacing supports with a top 10 and a bottom foam plate 10′, respectively.

The interconnected spacing supports 15 originate from a slotted parent block 1′, as described in FIGS. 5a to c, and the top 10 and the bottom 10′ foam plates are glued to the stretched configuration of spacing supports 15 in order to hold the stretched structure in place.

Between the Bonnell spring 72 and the toppers a thin sheat of stuffing 79 is inserted to which the topper 75 is glued to.

For the Bonnell coils 72 the stuffing 79 is hold in place by the rough surface of the outer rings and of the helical wire 77 structure and in addition, by the outer frame foam encasement 4,7 glued to the top 10 or bottom 10′ foam plates.

In the case of the pocket coils the toppers 75, 75′, can be pointwisely glued to the pocket Fabric for fixation.

The Bonnell multi storied mattress cores with the one sided topper 75 resembles to some extend and can reach the height of the fairly stiff box-spring mattresses, but yet is a mattress with two sides, one much softer and the other one quite hard.

Whereas the three storied core with the pocket coil middle 72′ part will give a very flexible, high mattress very usable also for motor- or adjusting underframes.

FIGS. 13a to c show the view onto and the cross section of inner damping cores for waterbeds consisting, e.g., of sinusoidal spacing supports 15 enclose in and clued to a frame of foam surrounding encasement beams 4, 7 and to outer foam stripes 71, 71′, on top and on bottom of the vertically arranged spacing supports 15 or are glued to a thin top 70 and bottom 70′ foam plate and an encasement 57, 54.

This damping core may float more or less freely in the water bed cover 74 or may be hooked by means of plastic bands (not shown) to eyes or rings vulcanized to the interior of the plastic waterbed hull 74. In FIG. 13d another two-story configuration with rows 75 of, e.g. sinusoidal spacing supports 15 are shown glued between three foam plates, a top 80′, middle 80, and a bottom 80′ one, which are connected and hold in place by glued—in inner stripes of foam or plastic bands inserted as a tongue into the ends of the spacing supports 15 rows 75 (not shown).

This two story configuration can also serve as normal multi-story, purely out of foam mattress core in normal mattresses and easily reached the height of a high American box-spring mattress.

1. Springy elements for the filling of mattress cores, upholstery, and pillows comprising elastic, compressible and flexible spacing supports out of foam or similar compressible material which are arranged as rib- or tube-like structures standing uprightly or lying horizontally in rows and connected to one another and which are arranged on and fixed to at least at one side to an elastically compressible deck plate or to a cover.

2. The unit of claim 1 further comprising
a) rows of sinusoidal, X-, V-, 8-shaped, hollow cylindrical or meander band shaped spacing supports out of foam or similar compressible material connected to one another with their plain of shape standing uprightly or lying horizontally between a top and a bottom plate or between a cover out of foam or any similar, resilient material, and
b) all rows are at least pointwisely glued and thus fixed to a top and a bottom plate or a cover and the side encasements at the touching plains

3. The unit of claim 1 further comprising
a) a cutting device by which slots are cut through a parent block out of foam in shifted rows such that one row of slots are open to one side of the inner core and the adjacent row has a closed end piece, and
b) glue is rolled or sprayed on said block on top and on the sides, and
c) by means of the prongs of a rake entering in the first and last row of slots the parent block is stretched from its length L′ to the final length L of the inner mattress core thus yielding a sinusoidal structure of uprightly standing interconnected ribs, and
d) the side and end beam encasements and the deck plate out of solid foam are glued and pressed to the inner core, and
e) after turning this preliminary unit the go through zeros of the sinusoidal ribs and the side encasement are coated with glue pointwisely or in stripes and then the bottom plate is pressed on, or
e) a stretching apparatus which is operating vertically and thus both sides of the unstretched, slotted parent block can be rolled or sprayed on with glue before stretching.

4. The unit of claim 1 further comprising
a) rows of sinusoidal spacing supports which are cut from a block of foam with a contour cutting machine, and
b) These rows of spacing supports are arranged with their plain of shape standing uprightly or lying horizontally between the plates or a cover out of foam to which they are glued, and neighbouring rows have a phase shift of 180 degrees and are glued to one another at their extrema and to the side encasement, and
c) Additional springy elements are placed into the slit-eyed openings between the rows of spacing supports.

5. The unit of claim 1 further comprising
a) stripes of foam from a parent block in which are cut comb-like slots from both sides, and
b) this block is pulled apart to rows of V-shaped spacing supports which are arranged with their plain of shape standing uprightly between the plates or a cover out of foam to which they are glued and to one another, and
c) in the lying horizontally case the rows of spacing supports are such glued to one another at the touching areas that rhombic or slit-eyed shaped openings result in which additional springy elements can be placed.

6. The unit of claim 1 further comprising
a) stripes of foam from a parent block in which are cut shorter and longer comb-like slots from both sides, and the latter are glued to form a closed end piece of the same length as for the shorter slots, and
b) these stripes of cutted foam are stretched apart to form X-shaped spacing supports, and
c) in the uprightly standing case the rows of spacing supports are such glued to one another at the touching areas, and
d) in the uprightly standing case the rows of X-shaped spacing supports are placed above one another and are glued to a two story mattress core.

7. The unit of claim 1 further comprising
a) one or two layers of spacing supports connected on one side to a deck plate and which are arranged as toppers on one or on both sides of a common mattress core out of Bonnell or pocket coils and which are connected to those, or
b) standing uprightly or lying horizontally spacing supports which are glued between deck plates or between stripes of foam which are placed in the hull of a waterbed in a one or two story version as an inner damping core.

8. Device for the production of a slotted parent block comprising
a) two pairs of differently large rollers driving a belt each which compress and transport a parent block through two rows of cutting knives going up an down, or
b) a mechanical cutting device consisting of rows of Guillotine-, or mincing knives-like, or triangular, thin cutting blades which run through slots of two plates compressing the parent block, with the blades or the plates vibrating in order to cut rows of slots in the block with uncut distance and end pieces, or
c) one or more high pressure waterjets which cut in one operation rows of slots with uncut distance and end pieces by turning the waterjets on and off when proceeding for the slot length l.

9. The unit of claims 1 comprising
a) a parent block which consists of zones of foam with different volume weight or Indention Force Deflection glued together, and
b) additional springy elements which are partly placed into the slit-eyed, rhombic or triangular openings of the sinusoidal, X-, V-, 8-shaped, hollow cylindrical or meander band shaped spacing supports.

10. Device for the producing sinusoidal spacing supports from a slotted parent block with transversally cut slots comprising
a) waggons which are fixed to the uncut end pieces by needles, and
b) waggons running in rails alongside of the foam block which are pulled apart by a multiple pair of scissors and are thus stretching the block from ist length L′ to the final length L of the inner mattress core or pillow, and
c) at least two pairs of large multiple scissors connected to the waggons at the ends of the foam block which stretch it longitudinally and compress it transversally in a synchronous movement from width B′ to the width B of the inner mattress core.

11. Device for producing X-shaped spacing supports comprising
a) a parent foam a block with alternating rows of longitudinal slots with thicker and shorter end pieces, and
d) waggons which are fixed to the uncut end pieces by means of hooking-iron-like needles, and
c) which are pulled apart for the transverse spreading of the block by at least two large pairs of multiple scissors in an analogous movement to that in claim 10 c), and here the block is longitudinally compressed from length L′ to length L of the inner mattress core until the shorter end pieces touch and thus are glued together form the side encasement.

12. Device for the producing meandering band-like spacing supports comprising
a) two crosses of four arms each at the end of which forming post are connected which are standing uprightly and which interlock like gear wheels, such that
b) the foam band fed in from one side is formed to the meandering band by the forming posts and then is glued together at the touching point areas, and
c) forming post which after the forming are pushed from the arms downwardly and are raised cosecutively on a snake-like band after a ¾ turn back into the arms of the cross and clicked in again, or
d) the forming posts are replaced by cylindrical or barrel shaped spiral springs which are placed in the openings of the meandering band-like spacing supports.
